(19) United States
(12) Patent Application Publication
(10) Pub. No.: US 2005/0271032 A1
(43) Pub. Date: Dec. 8, 2005

(54) Communication method and apparatus in mobile station having multiple interfaces

(75) Inventors: Won-dong Yun, Seoul (KR); Young-keun Kim, Metropolitan-City (KR); Pyung-soo Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/125,337

(22) Filed: May 10, 2005

(30) Foreign Application Priority Data
May 10, 2004 (KR) 2004-32595

(51) Int. Cl. H04L 12/66

(52) U.S. Cl. 370/349

(57) ABSTRACT

Provided are wireless communication methods and apparatus. The communication method for a mobile station in which multiple interfaces complying with different communication standards are loaded includes obtaining an address that can be used for communication through every one of multiple interfaces based on information regarding a predetermined interface among the multiple interfaces; and performing communication through one of the multiple interfaces using the obtained address. The mobile station has no need to generate an IP address for each of the multiple stations.

### CROSS-REFERENCE TO RELATED APPLICATION

This application claims the benefit of Korean Patent Application No. 2004-32595, filed on May 10, 2004, in the Korean Intellectual Property Office, the disclosure of which is incorporated herein in its entirety by reference.

### BACKGROUND OF THE INVENTION

1. Field of the Invention

The present invention relates to a wireless communication method and apparatus.

2. Description of the Related Art

3GPP (3 Generation Partnership Project), WLAN (wireless local area network), and Bluetooth are wireless communication standards. These standards are different in wireless communication support range, quality, and cost. The 3GPP standard, which supports the widest wireless communication range among the three standards, is most widely used in mobile phones. The WLAN standard, which supports a medium wireless communication range, is used for device-to-device wireless communication in offices. The Bluetooth standard, which supports the narrowest wireless communication range among the three standards, is used for device-to-device wireless communication at home.

FIG. 1 is a flowchart of a conventional 3GPP communication method. Referring to FIG. 1, the conventional 3GPP communication method includes the following operations. In operation 101, a mobile station (MS) 11 transmits an activate PDP (Packet Data Protocol) context request message to a SGSN (Serving GPRS (General Packet Radio Service (GPRS) Support Node) 13 via a BSS/UTRAN (Base Station Subsystem/UMTS (Universal Mobile Telecommunications System) Radio Access Network) 12. Nothing is recorded in a PDP address field of the activate PDP context request message. Subsequently, the SGSN 13 receives the activate PDP context request message.

In operation 102, the SGSN 13 transmits a create PDP context request message to a GGSN (Gateway GPRS Support Node) 14 via a 3GPP backbone. Thereafter, when the create PDP context request message is received, the GGSN 14 generates interface identifiers and then link local IP (Internet Protocol) addresses based on the interface identifiers. The GGSN 14 respectively assigns mobile stations which are managed whereby the interface identifiers stored in an interface identifier pool of the GGSN 14 do not overlap. Since the GGSN 14, a type of router, generates and assigns addresses, this method is a stateful address configuration method. Thus, duplicate address detection with respect to the link local IP addresses is unnecessary.

In operation 103, the GGSN 14 transmits a create PDP context response message including a link local IP address to the SGSN 13 via the 3GPP backbone. The link local IP address is recorded in a PDP address field of the create PDP context response message. The SGSN 13 receives the create PDP context response message and extracts the link local IP address from the received create PDP context response message.

In operation 104, the SGSN 13 transmits an activate PDP context accept message including the extracted link local IP address to the MS 11 via the BSS/UTRAN 12. The link local IP address is recorded in a PDP address field of the activate PDP context accept message. Subsequently, the MS 11 receives the activate PDP context accept message and extracts the link local IP address from the received activate PDP accept message. Thereafter, the MS 11 extracts the interface identifier from the extracted link local IP address.

In operation 105, the MS 11 transmits a router solicitation message requesting a network prefix of a subnet in which the MS 11 is currently located to the GGSN 14 via the BBS/UTRAN 12 and the SGSN 13. The GGSN 14 receives the router solicitation message.

In operation 106, the GGSN 14 transmits a router advertisement message including the network prefix of the subnet in which the MS 11 is currently located to the MS 11 via the SGSN 13 and the BSS/UTRAN 12. The MS 11 receives the router advertisement message and extracts the network prefix from the received router advertisement message. Next, the MS 11 generates a global IP address by combining the interface identifier with the network prefix.

In operation 107, the MS 11 transmits a neighbor solicitation message including the global IP address to the GGSN 14 via the BSS/UTRAN 12 and the SGSN 13 for duplicate address detection with respect to the global IP address. Subsequently, the GGSN 14 receives the neighbor solicitation message and discards the received neighbor solicitation message. The global IP address is a unique address because it is generated based on the interface identifier extracted from the link local IP address that has been verified not to be duplicated through duplicate address detection. Therefore, duplicate address detection with respect to the global IP address is unnecessary, and thus the GGSN 14 discards the received neighbor solicitation message.

In operation 108, the MS 1 performs PDP context modification based on the activate PDP context accept message.

FIG. 2 is a flowchart of a conventional WLAN communication method or Bluetooth communication method. Referring to FIG. 2, the conventional WLAN communication method or Bluetooth communication method includes the following operations. In operation 201, a mobile station (MS) 21 generates an arbitrary link local IP address and transmits a neighbor solicitation message including the link local IP address to an access router (AR) 23 via an access point (AP) 22 for duplicate address detection with respect to the link local IP address. Since the mobile station 21 arbitrarily generates the link local IP address, this operation corresponds to a stateless address configuration method. Therefore, duplicate address detection with respect to the link local IP address is necessary. Subsequently, the AR 23 receives the neighbor solicitation message and extracts the link local IP address from the neighbor solicitation message.

In operation 202, the AR 23 performs duplicate address detection with respect to the link local IP address and transmits a neighbor advertisement message to the MS 21 via the AP 22 if the link local IP address has a duplicate.

In operation 203, the MS 21 transmits a router solicitation message requesting a network prefix of a subnet in which the mobile station 32 is currently located to the AR 23 via the AP 22. Next, the AR 23 receives the router solicitation message.

In operation 204, the AR 23 transmits a router advertisement message including the network prefix of the subnet in which the MS 21 is currently located to the MS 21 via the AP 22. Then, the MS 21 receives the router advertisement message and extracts the network prefix from the received router advertisement message. Thereafter, the MS 21 generates a global IP address by combining an interface identifier with the network prefix.

In operation 205, the MS 21 transmits the neighbor solicitation message including the global IP address to the AR 23 via the AP 22. Subsequently, the AR 23 receives the neighbor solicitation message and extracts the global IP address from the received neighbor solicitation message.

In operation 206, the AR 23 performs duplicate address detection with respect to the global IP address and transmits the neighbor advertisement message to the MS 21 via the AP 22 if the link local IP address has a duplicate.

The global IP address is a unique address because it is generated based on the interface identifier extracted from the link local IP address that determined to be unique through duplicate address detection. Accordingly, duplicate address detection with respect to the global IP address is unnecessary. Therefore, operations 205 and 206 can be omitted.

If a certain mobile station includes multiple interfaces, for example, a 3GPP interface, a WLAN interface, and a Bluetooth interface, IP addresses have to be obtained via additional processes as illustrated in FIGS. 1 and 2. Therefore, too many IP addresses are assigned to one mobile station and it takes a considerable amount of time to perform such additional processes on each of the IP addresses. In particular, a considerable amount of time is required for duplicate address detection, thereby resulting in loss of packets and performance deterioration.

In addition, since the GGSN generates a link local IP address and transmits it to the mobile station, the interface identifier pool has to be continuously managed to guarantee the uniqueness of the link local IP address. Furthermore, due to a limited capacity of the interface identifier pool, only a limited number of mobile stations can be connected to the GGSN.

### SUMMARY OF THE INVENTION

An aspect of the present invention provides a communication method and apparatus in a mobile station in which multiple interfaces complying with different communication standards are loaded, in which it is unnecessary to generate an IP address for each of the multiple interfaces, and in which limited capacity of an interface identifier pool in a GGSN (Gateway GPRS (General Packet Radio Service) Support Node) is addressed.

According to an aspect of the present invention, there is provided a communication method in a mobile station in which multiple interfaces complying with different communication standards are loaded, the method comprising: (a) obtaining an address that can be used in communication through every one of the multiple interfaces based on information regarding a predetermined interface among the multiple interfaces; and (b) performing communication through one of the multiple interfaces using the address obtained in (a).

According to anther aspect of the present invention, there is provided a communication apparatus in a mobile station in which multiple interfaces complying with different communication standards are loaded, the communication apparatus comprising: an address obtaining unit obtaining an address that can be used in communication through every one of the multiple interfaces based on information regarding a predetermined interface among the multiple interfaces; and a communication performing unit performing communication through one of the multiple interfaces using the address obtained in the address obtaining unit.

According to another aspect of the present invention, there is provided an address obtaining method in a mobile station in which multiple interfaces complying with different communication standards are loaded, the method comprising: (a) requesting an address that can be used in communication through every one of multiple interfaces; (b) receiving a response to the request in (a); and (c) extracting the address from the response received in (b).

According to anther aspect of the present invention, there is provided an address providing method comprising: (a) generating an address that can be used in communication through every one of multiple interfaces based on information regarding a predetermined interface amount the multiple interfaces complying with different communication standards; and (b) transmitting the address generated in (a) to a mobile station in which the multiple interfaces are loaded.

According to another aspect of the present invention, there is provided a computer readable medium having embodied thereon instructions comprising a communication method in a mobile station in which multiple interfaces complying with different communication standards are loaded, the communication method comprising: obtaining an address that can be used in communication through every one of the multiple interfaces based on information regarding a predetermined interface among the multiple interfaces; and performing communication through one of the multiple interfaces using the obtained address.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart of a conventional 3GPP communication method;

FIG. 2 is a flowchart of a conventional WLAN communication method or Bluetooth communication method;

FIG. 3 is a diagram illustrating a communication environment according to an embodiment of the present invention;

FIG. 4 is a configuration diagram of a communication apparatus according to an embodiment of the present invention;

FIG. 5 is a configuration diagram of a global address obtaining unit in FIG. 4;

FIG. 6 is a configuration diagram of a global address providing apparatus according to an embodiment of the present invention;

FIG. 7 is a flowchart of a communication method according to an embodiment of the present invention;

FIG. 8 is a flowchart of an operation of obtaining a global IP address 74 (FIG. 7), according to an embodiment of the present invention;

FIG. 9 is a flowchart of a global address providing method according to an embodiment of the present invention;

FIG. 10 is a flowchart of a 3GPP communication method according to an embodiment of the present invention; and

FIG. 11 is a flowchart of a WLAN or Bluetooth communication method according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

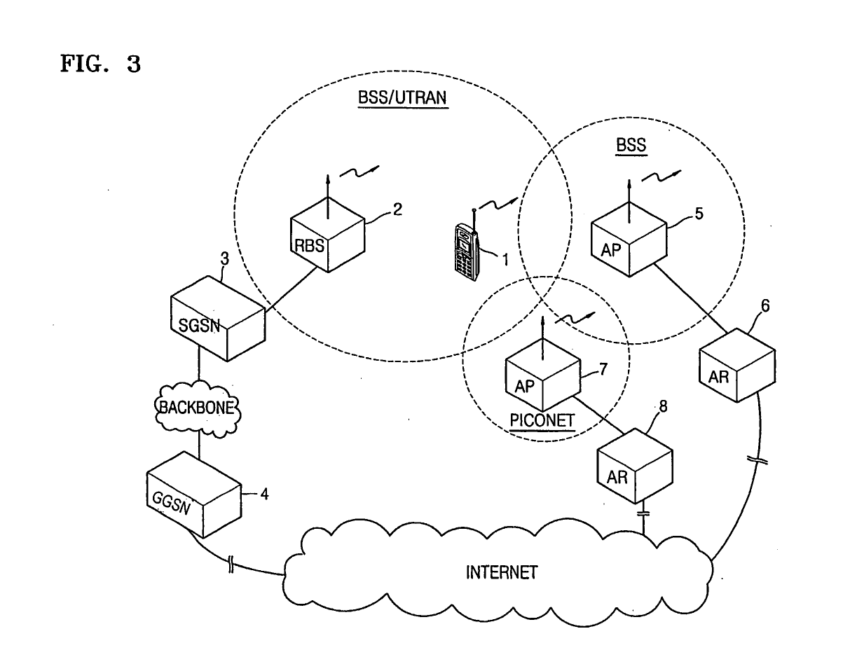

FIG. 3 is diagram illustrating a communication environment according to an embodiment of the present invention. Referring to FIG. 3, the communication environment according to the present invention includes a mobile station 1, a radio base station (RBS) 2, a serving GPRS (general packet radio service) support node (SGSN) 3, a gateway GPRS support node (GGSN) 4, access points (APs) 5 and 7, and access routers (ARs) 6 and 8. The communication environment according to the present embodiment is illustrated in a simple manner to help understanding of the environment. Therefore, the communication environment may further include other devices when practically implemented.

The mobile station 1 includes multiple interfaces complying with different communication standards.

The RBS 2 complies with the 3GPP (3 Generation Partnership Project) standard and connects the mobile station 1, which is located a distance from the RBS 2 to which radio waves emitted from the RBS 2 can be transmitted to effect communication, i.e., in a domain managed by the RBS 2. The domain managed by the RBS 2 is referred to as a BSS/UTRAN (Base Station Subsystem/Universal mobile Telecommunications system Radio Access Network).

The SGSN 3 complies with the 3GPP standard, is located between the RBS 2 and the GGSN 4, and connects the RBS 2 and the GGSN 4 via a 3GPP backbone. The GGSN 4 complies with the 3GPP standard and connects the SGSN 3 to an external packet-based network such as the Internet.

The AP 5 complies with the WLAN standard and connects the mobile station 1, which is located a distance from the AP 5 to which radio waves emitted from the AP 5 can be transmitted to effect communication, i.e., in a domain managed by the AP 5, to a wired network. The domain managed by the AP 5 is referred to as a BSS (Basic Service Set). The AR 6 complies with the WLAN standard and connects the AP 5 to an external packet-based network such as the Internet.

The AP 7 complies with the Bluetooth standard and connects the mobile station 1, which is located within an effective distance of radio waves transmitted from the AP 7, i.e., a domain managed by the AP 7. The domain managed by the AP 7 is referred to as a piconet. The AR 8 complies with the Bluetooth standard and connects the AP 7 to an external packet-based network such as the Internet.

A user of the mobile station 1 can be provided with one communication service or simultaneously with multiple communication services depending on where the user is currently located. A communication service having the highest signal intensity among other communication services may be automatically selected. Alternatively, the user may select proper communication services in consideration of uses, qualities and charges of communication services.

In the embodiments described below, multiple interfaces may include a 3GPP interface and a WLAN interface or a 3GPP interface and a Bluetooth interface. Further, it will be understood by those of ordinary skill in the art that the multiple interfaces of the embodiments described below could be other various interfaces for wireless communication and the 3GPP interface.

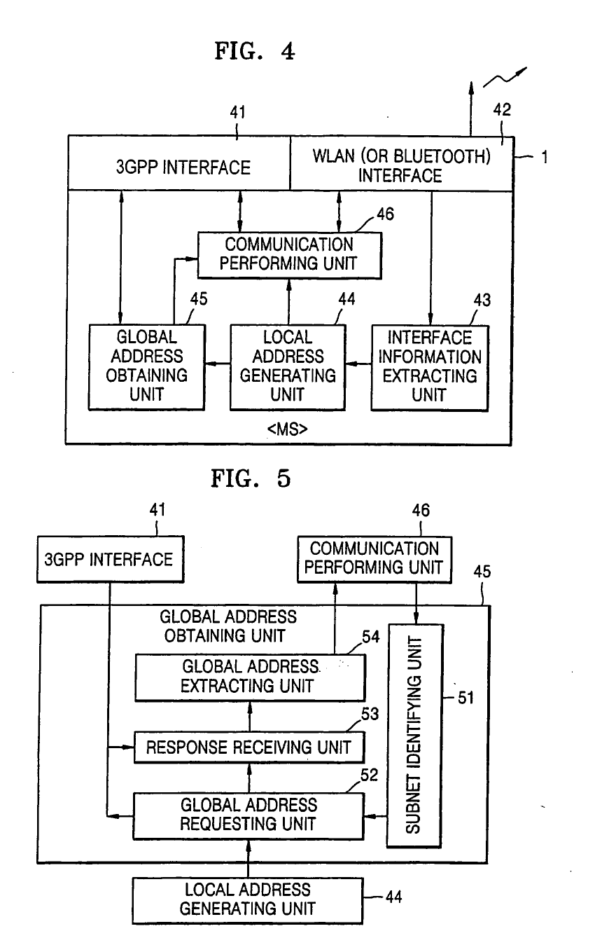

FIG. 4 is a configuration diagram of a communication apparatus according to an embodiment of the present invention.

Referring to FIG. 4, the communication apparatus according to an embodiment of the present invention includes an interface information extracting unit 43, a local address generating unit 44, a global address obtaining unit 45, and a communication performing unit 46. The communication apparatus according to the present invention is loaded in an upper layer above a network layer of the mobile station 1 shown in FIG. 3. The mobile station 1 includes multiple interfaces complying with different communication standards, in addition to the communication apparatus. The multiple interfaces correspond to a lower layer below a link layer. The communication apparatus according to the present invention communicates with the outside through the multiple interfaces.

The interface information extracting unit 43 extracts information regarding a WLAN (or Bluetooth) interface 42 from the WLAN (or Bluetooth) interface 42 among the multiple interfaces. In the present embodiment, the information regarding the WLAN (or Bluetooth) interface 42 is a media access control (MAC) address according to the IEEE 802 standard. The MAC address is a 48-bit physical address assigned by a WLAN (or Bluetooth) interface manufacturing company and is stored in a register in the WLAN (or Bluetooth) interface 42. That is, the interface information extracting unit 43 reads the MAC address of the WLAN (or Bluetooth) interface 42 from the register in the WLAN (or Bluetooth) interface 42.

The local address generating unit 44 generates a local address based on the information regarding the WLAN (or Bluetooth) interface 42. In the present embodiment, the local address is an address that can be used for local communication through a 3GPP interface 41 or the WLAN (or Bluetooth) interface, and in particular, a link local IP address according to an IPv6 (Internet Protocol version 6) standard. In other words, the local address is an address that can be used only in a link in which the mobile station 1 is currently located through the 3GPP interface 41 or the WLAN (or Bluetooth) interface 42.

That is, the local address generating unit 44 generates the link local IP address by combining a link local prefix FE80:: according to the IPv6 standard with the MAC address of the WLAN (or Bluetooth) interface 42. In particular, the 128-bit link local IP address consists of a 64-bit link local prefix FE80:: and a 64-bit interface identifier. The 64-bit interface identifier consists of 24 bits of the first half of the MAC address of the WLAN (or Bluetooth) interface 42, a 16-bit FFFE, and 24 bits of the second half of the MAC address of the WLAN (or Bluetooth) interface 42.

The global address obtaining unit 45 obtains a global address that can be used for global communication through every one of the multiple interfaces based on information regarding a predetermined interface among the multiple interfaces, i.e., the MAC address of the WLAN (or Bluetooth) interface 42. Alternatively, the global address could be used for global communication through a plurality of the multiple interfaces. In the present embodiment, the global address refers to an address that can be used for global communications through the multiple interfaces, particularly, a global IP address according to the IPv6 standard. That is, the global IP address refers to an IP address that can be used over the Internet through the multiple interfaces.

In particular, the 128-bit global IP address consists of a 64-bit network prefix and a 64-bit interface identifier. The 64-bit interface identifier consists of 24 bits of the first half of the MAC address of the WLAN (or Bluetooth) interface 42, a 16-bit FFFE, and 24 bits of the second half of the MAC address of the WLAN (or Bluetooth) interface 42. This interface identifier is identical with the interface identifier included in the link local IP address generated by the local address generating unit 44. Therefore, the link local IP address can be converted to the global IP address by replacing the link local prefix FE80:: with the network prefix where the mobile station 1 is currently located.

That is, the global address obtaining unit 45 provides the local address generated by the local address generating unit 14 to an external device that can generate a global address, and obtains the global address from the external device.

FIG. 5 is a configuration diagram of a global address obtaining unit (FIG. 4), according to an embodiment of the present invention. Referring to FIG. 5, the global address obtaining unit 45 includes a subnet identifying unit 51, a global address requesting unit 52, a response receiving unit 53, and a global address extracting unit 54.

The subnet identifying unit 51 identifies a subnet where the mobile station 1 is currently located. That is, the subnet identifying unit 51 identifies the subnet where the mobile station is currently located by checking a network prefix of the subnet.

When the mobile station 1 has no global address or when a subnet previously identified by the subnet identifying unit 51 differs from the subnet currently identified by the subnet identifying unit 51, that is, when the network prefix of the subnet is changed, the global address requesting unit 52 requests the external device to generate a global address.

In the present embodiment, the external device is the GGSN 4 in FIG. 3. The GGSN 4 is a router routing a packet transmitted from the mobile station 1 to the Internet. Therefore, the external device knows about the network prefix of the subnet where the mobile station 1 is currently located. However, the GGSN 4 does not know about the interface identifier generated based on the MAC address of the WLAN (or Bluetooth) interface 42 loaded in the mobile station 1. Accordingly, the mobile station 1 has to provide an interface identifier to the GGSN 4.

In particular, the global address requesting unit 52 transmits a global address request message including the local address generated by the local address generating unit 44. Described using 3GPP terminology, the global address requesting unit 52 transmits an activate PDP (Packet Data Protocol) context request message including the link local IP address generated by the local address generating unit 44 to the SGSN 3. The SGSN 3 and the GGSN 4 are connected by the 3GPP backbone.

The response receiving unit 53 receives a response to the request of the global address requesting unit 52. That is, the response receiving unit 53 receives a response message including a global address converted from the local address that is included in the global address request message transmitted from the global address requesting unit 52. Described using 3GPP terminology, the response receiving unit 53 receives from the SGSN 3 an activate PDP context accept message including a global IP address corresponding to the link local IP address included in the active PDP context request message transmitted from the global address requesting unit 52.

The global address extracting unit 54 extracts the global address from the response message received by the response receiving unit 53. Described using 3GPP terminology, the global address extracting unit 54 extracts the global IP address from the activate PDP context accept message received by the response receiving unit 53.

Referring to FIGS. 3-5, the communication performing unit 46 performs communication through one of the multiple interfaces, i.e., the 3GPP interface 41 or the WLAN (or Bluetooth) interface 42 using the global address obtained by the global address obtaining unit 45, i.e., the global address extracted by the global address extracting unit 54. Further, when information indicating that the local address has a duplicate is received from the communication performing unit 46 via the SBSN 3, the communication performing unit 46 deals with the local address problem according to a duplicate address process method. For example, a non-duplicate address can be assigned by an external device according to a stateful address configuration method.

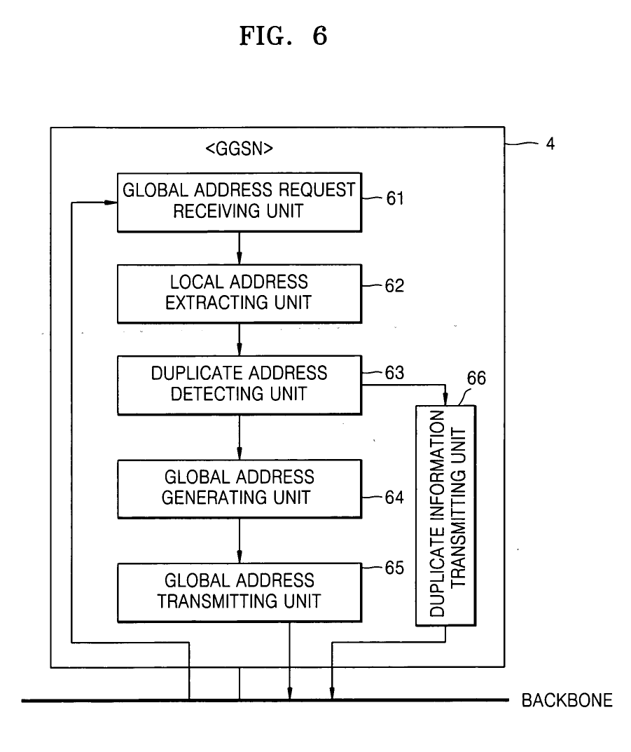

FIG. 6 is a configuration diagram of a global address providing apparatus according to an embodiment of the present invention. Referring to FIG. 6, the global address providing unit according to an embodiment of the present invention includes a global address request receiving unit 61, a local address extracting unit 62, a duplicate address detecting unit 63, a global address generating unit 64, a global address transmitting unit 65, and a duplicate information transmitting unit 66. The global address providing apparatus is loaded in the GGSN 4 in FIG. 3.

The global address request receiving unit 61 receives a global address request issued by the mobile station 1 in FIG. 3. That is, the global address request receiving unit 61 receives a global address request message including a local address that is transmitted from the mobile station 1. Described using 3GPP terminology, the global address request receiving unit 61 receives a create PDP context request message including a local IP address from the SGSN 3 via the 3GPP backbone.

The local address extracting unit 62 extracts the local address from the global address request message received by the global address request receiving unit 61. Described using 3GPP terminology, the local address extracting unit 62 extracts a link local IP address from the create PDP context request message received by the global address request receiving unit 61.

The duplicate address detecting unit 63 detects whether the link local IP address extracted from the local address extracting unit 62 is a link local IP address, i.e., a duplicate address, in use by anther mobile station, not the mobile station 1. The duplicate address detecting unit 63 constructs a database of link local IP addresses previously extracted by the local address extracting unit 62 and can identify whether the link local IP address extracted by the local address extracting unit 62 is a duplicate address based on the database.

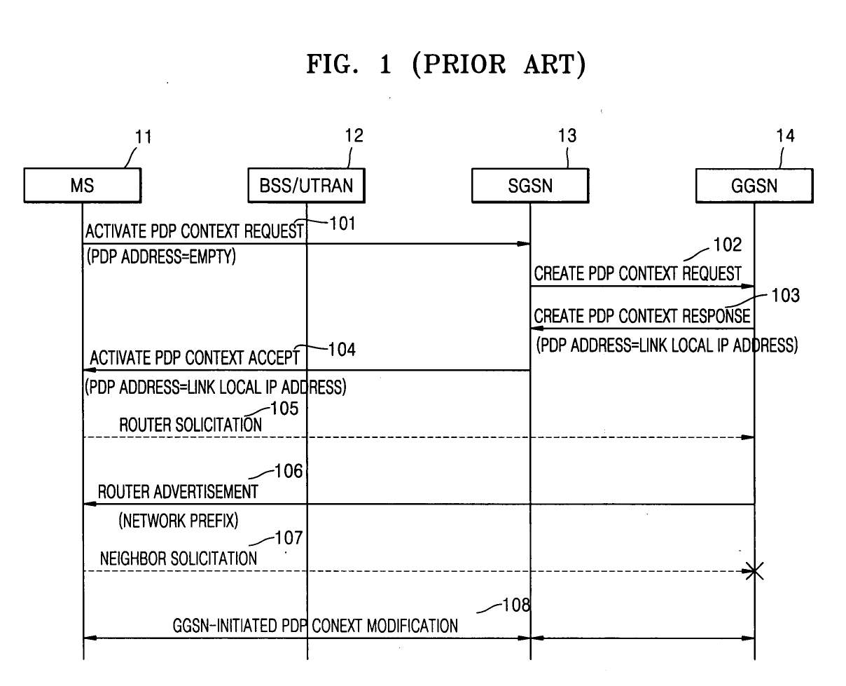

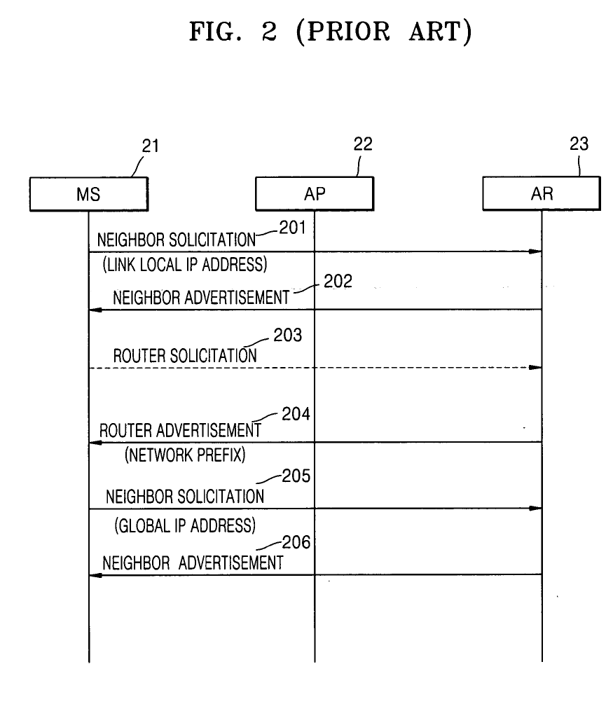

The GGSN 14 according to the conventional 3GPP communication method described with reference to FIG. 1 respectively assigns interface identifiers stored in the interface identifier pool therein to mobile stations which are managed by the GGSN 14 not to be duplicated for the mobile stations. Since the GGSN 14, which is a type of router, generates and assigns addresses, the conventional method is a stateful address configuration method. Therefore, no duplicate address detection with respect to the link local IP address is required. However, in the embodiment according to the present invention, the mobile station 1 generates an arbitrary link local IP address. Therefore, the method used in the present invention is a stateless address configuration method. Accordingly, the GGSN 4 has to perform duplicate address detection.

The global address generating unit 64 generates a global address that can be used for global communication through every multiple interface based on the information regarding the WLAN (or Bluetooth) interface 42. That is, when it is determined by the duplicate address detecting unit 63 that the local address extracted from the local address extracting unit 62 is not a link local IP address used by other mobile stations, the global address generating unit 64 converts the extracted local address to the global address.

In particular, the global address generating unit 64 replaces a link local prefix FE80:: of the link local IP address, which is extracted by the local address extracting unit 62, with a network prefix in which the mobile station 1 is currently located to convert the link local IP address to a global IP address. This global IP address is a unique address because it is generated based on the interface identifier extracted from the link local IP address determined to be unique through the duplicate address detection process. Therefore, duplicate address detection with respect to the global IP address is unnecessary.

The global address transmitting unit 65 transmits the global address generated by the global address generating unit to the mobile station 1 in which the multiple interfaces are loaded. Described using 3GPP terminology, the global address transmitting unit 65 transmits to the SGSN 3 a create PDP context response message including the global IP address generated by the global address generating unit 65. The SGSN 3 receives the create PDP context response message, extracts the global IP address from the received create PDP context response message, and transmits the activate PDP context accept message including the extracted global IP address to the mobile station 1.

The duplicate information transmitting unit 66 transmits to the mobile station 1 via the SGSN 3, etc. information regarding the result of detection by the duplicate address detecting unit 63, i.e., information regarding whether the link local IP address included in the global address request message transmitted from the mobile station 1 is a duplicate address.

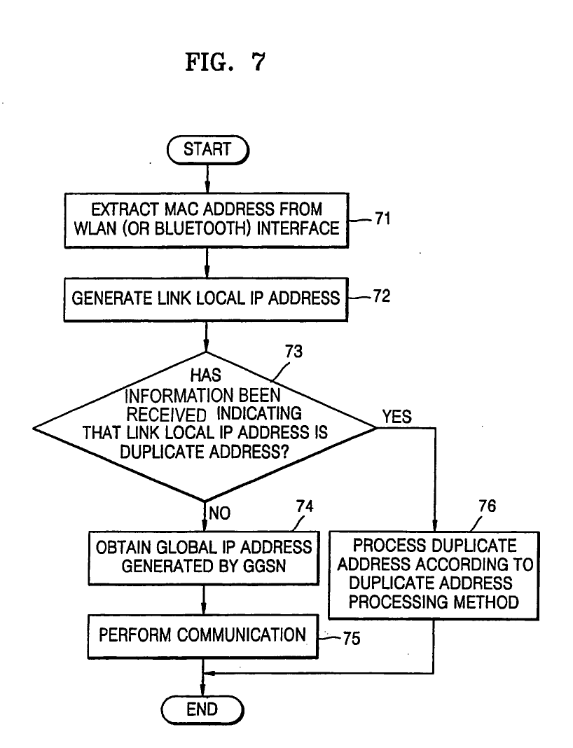

FIG. 7 is a flowchart of a communication method according to an embodiment of the present invention. Referring to FIG. 7, the communication method according to the present embodiment includes the following operations. The communication method according to the present invention includes time-series processes performed in the communication apparatus illustrated in FIG. 4. Accordingly, the above-descriptions on the communication apparatus of FIG. 4 will apply to the communication method described below.

In operation 71, the mobile station 1 extracts information regarding the WLAN (or Bluetooth) interface 42 from the WLAN (or Bluetooth) interface 42 among the multiple interfaces. In the present embodiment, the information regarding the WLAN (or Bluetooth) interface 42 refers to a MAC address according to the IEEE 802 standard.

In operation 72, the mobile station 1 generates a local address based on the information regarding the WLAN (or Bluetooth) interface 42. In the present embodiment, the local address refers to an address that can be used for local communication through the 3GPP interface 41 or the WLAN (or Bluetooth) interface 42, particularly, a link local IP address according to the IPv6 standard. In other words, in operation 72, the mobile station 1 generates the link local IP address based on the MAC address of the WLAN (or Bluetooth) interface 42.

In operation 73, the mobile station 1 receives information indicating that the local address is a duplicate address from the GGSN 4 via the SGSN 3, etc.

If the information indicating that the local address is a duplicate address, is not received in operation 73, the mobile station 1 obtains a global address that can be used for global communication through every multiple interface based on the information regarding a predetermined interface among the multiple interfaces, i.e., the MAC address of the WLAN (or Bluetooth) interface 42. In the present embodiment, the global address refers to an address that can be used for global communication through every multiple interface, particularly, a global IP address according to the Ipv6 standard. In other words, in operation 74, the mobile station 1 can obtain a global address by providing the local address generated in operation 72 to the GGSN 4, which generates the global address.

In operation 75, the mobile station 1 performs communication through one of the multiple interfaces, i.e., the 3GPP interface 41 or the WLAN interface (or Bluetooth) interface 42 using the global address obtained in operation 74.

If the information indicating that the local address is a duplicate address, is received in operation 73, the mobile station 1 deals with the local address problem using a duplicate address processing method 76.

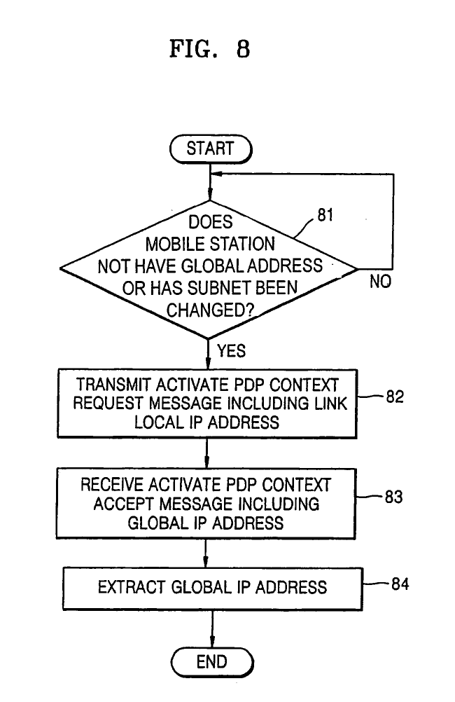

FIG. 8 is a detailed flowchart of an operation of obtaining a global IP address 74 (FIG. 7), according to an embodiment of the present invention. Referring to FIG. 8, operation 74 in FIG. 7 includes the following operations. The operation 74 illustrated FIG. 7 includes time-series processes performed by the global address obtaining unit 45 in FIG. 5. Accordingly, the above-descriptions on the communication apparatus of FIG. 5 will apply to operation 74 in FIG. 8.

In operation 81, the mobile station 1 checks whether it has a global address and identifies the subnet in which the mobile station 1 is currently located.

When it is confirmed that the mobile station 1 does not have a global address in operation 81, or when a previously identified subnet differs from the currently identified subnet, i.e., when the network prefix of the subnet is changed, the mobile station 1 requests an external device to generate a global address in operation 82. Described using 3GPP terminology, in operation 82, the mobile station 1 transmits the activate PDP context request message including the link local IP address generated in operation 72 to the SGSN 3.

In operation 83, the mobile station 1 receives a response to the request in operation 82. That is, in operation 83, the mobile station 1 receives a response message including the global address converted from the local address included in the global address request message transmitted in operation 82. Described using 3GPP terminology, in operation 83, the mobile station 1 receives from the SGSN 3 an activate PDP context accept message including a global IP address corresponding to the link local IP address included in the activate PDP context request message transmitted in operation 81.

In operation 84, the mobile station 1 extracts the global address from the response message received by the response receiving unit 53. Described using 3GPP terminology, in operation 84, the mobile station 1 extracts the global IP address from the activate PDP context accept message received in operation 83.

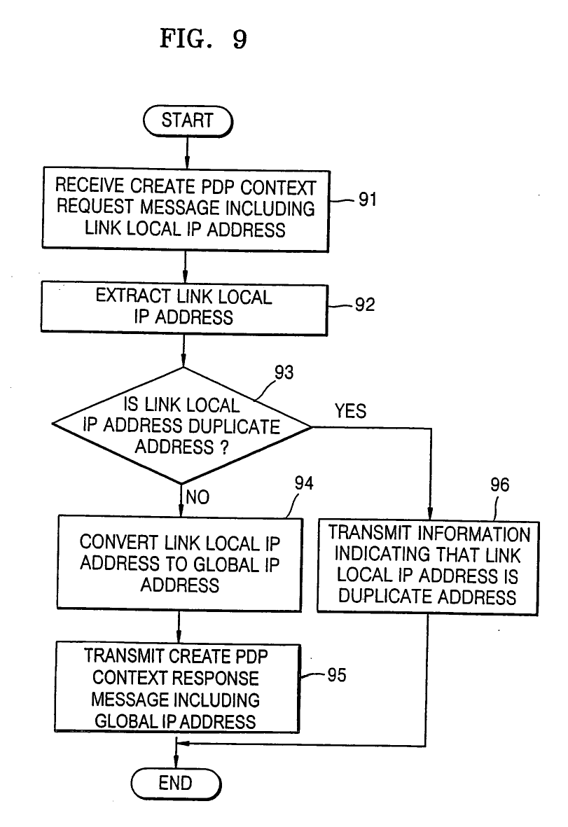

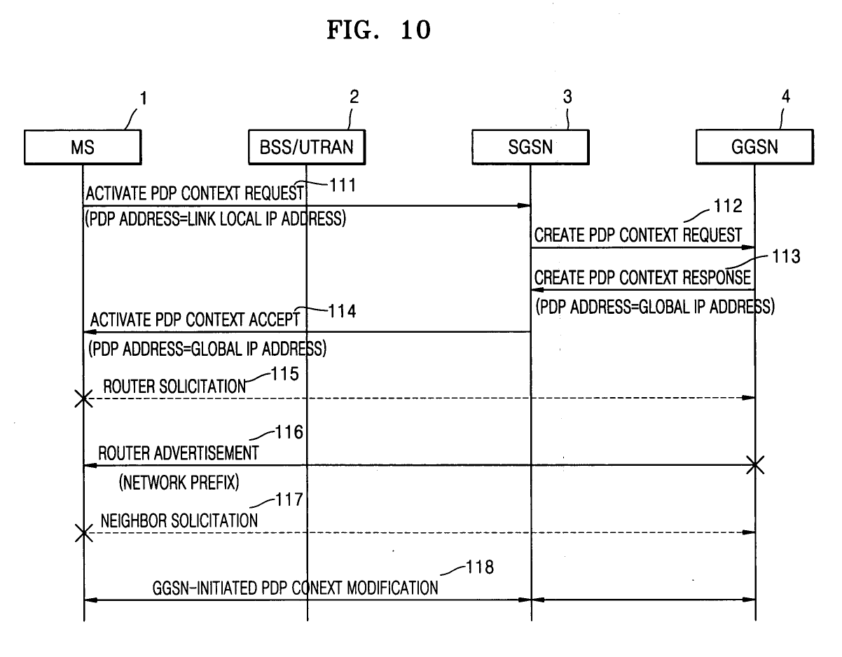

FIG. 9 is a flowchart of a global address providing method according to an embodiment of the present invention. Referring to FIG. 9, the global address providing method according to the present invention includes the following operations. The global address providing method includes time-series processes performed in the global address providing apparatus in FIG. 6. Accordingly, the above-descriptions on the global address providing apparatus in FIG. 6 will apply to the global address providing method in FIG. 9.

In operation 91, the GGSN 4 receives a request for a global address issued by the mobile station 1 in FIG. 3. That is, in operation 91, the GGSN 4 receives a global address request message including a local address that is issued by the mobile station 1. Described using 3GPP terminology, in the operation 91, the GGSN 4 receives a create PDP context request message including a link local IP address from the SGSN 3 via the 3GPP backbone.

In operation 92, the GGSN 4 extracts the local address from the global address request message received in operation 91. Described using 3GPP terminology, in operation 92, the GGSN 4 extracts the link local IP address from the create PDP context request message received in operation 91.

In operation 93, the GGSN 4 checks whether the link local IP address extracted in operation 92 is in use by another mobile station, not the mobile station 1, i.e., whether the link local IP address is a duplicate address. In operation 93, the GGSN 4 constructs a database of link local IP addresses which are previously extracted by the local address extracting unit 62 and identifies whether the link local IP address extracted by the local address extracting unit 62 is a duplicate address by inquiring the database.

In operation 94, the GGSN 4 generates a global address that can be used for global communication through every multiple interface based on the information regarding the WLAN (or Bluetooth) interface 42. That is, in operation 94, when it is determined in operation 83 that the link local IP address is not in use by another mobile station, the GGSN 4 converts the link local IP address extracted in operation 92 to a global IP address.

In operation 95, the GGSN 4 transmits the global address generated in operation 94 to the mobile station 1 in which the multiple interfaces are loaded. Described using 3GPP terminology, in operation 95, the GGSN 4 transmits a create PDP context response message including the global IP address generated in operation 94 to the SGSN 3 via the 3GPP backbone.

In operation 96, when it is determined in operation 93 that the link local IP address is in use by another mobile station, the GGSN 4 transmits information indicating that the link local IP address is a duplicate address to the mobile station 1 via the SGSN 3, etc.

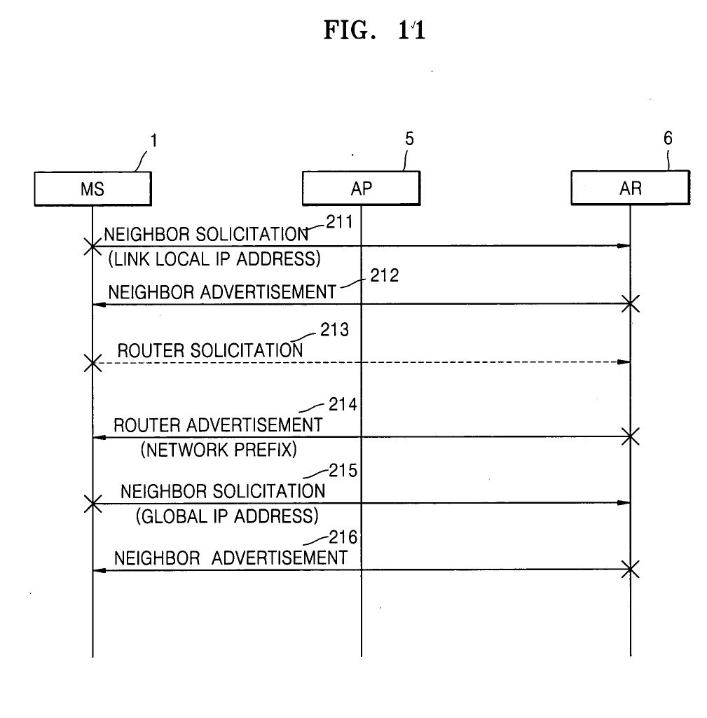

FIG. 10 is a flowchart of a 3GPP communication method according to an embodiment of the present invention. Referring to FIG. 10, the 3GPP communication method according to the present embodiment includes the following operations. In operation 111, a mobile station 1 transmits an activate PDP context request message including a link local IP address to a SGSN 3 via a BSS/UTRAN 2, i.e., a RBS 2. The link local IP address is recorded in a PDP address field of the activate PDP context request message. Subsequently, the SGSN 3 receives the activate PDP context request message and extracts the link local IP address from the received activate PDP context request message.

In operation 112, the SGSN 3 transmits a create PDP context request message including the extracted link local IP address to the GGSN 4 via a 3GPP backbone. Thereafter, the GGSN 4 receives the create PDP context request message including the link local IP address and extracts the link local IP address from the received create PDP context request message. Next, the GGSN 4 checks whether the link local IP address is a duplicate address. If it is confirmed that the link local IP address is not a duplicate address, the GGSN 4 converts the link local IP address to a global IP address.

In operation 113, the GGSN 4 transmits a create PDP context response message including a response message to the SGSN 3 via the 3GPP backbone. The global IP address is recorded in a PDP address filed of the create PDP context response request message. Next, the SGSN 3 receives the create PDP context response message and extracts the response message from the received create PDP context response message.

In operation 114, the SGSN 3 transmits an activate PDP context accept message including the extracted global IP address to the mobile station 1 via the BSS/UTRAN 2, i.e., the RBS 2, etc. The global IP address is recorded in a PDP address field of the activate PDP context accept message. Thereafter, the mobile station 1 receives the activate PDP context accept message and extracts the global IP address from the received activate PDP context accept message.

In the 3GPP communication method according to the present embodiment, operations 115, 116, and 117 that are necessary in the conventional 3GPP communication method are not required. This is because the mobile station 1 is provided with the global IP address that is generated by the GGSN 4. Accordingly, there is no need to perform operations 115, 116 and 117 of generating the global IP address.

In operation 118, the mobile station 1 performs PDP context modification based on the activate PDP context accept message.

FIG. 11 is a flowchart of a WLAN (or Bluetooth) communication method according to an embodiment of the present invention. Referring to FIG. 11, in the WLAN (or Bluetooth) communication method according to the present invention, operations 211, 212, 213, 214, 215, and 216, which are necessary in the conventional WLAN (or Bluetooth) communication method, are unnecessary. This is because the mobile station 1 generates a link local IP address, and duplicate address detection is performed in the GGSN 4. Accordingly, there is no need to perform operations 211 and 212 of generating the link local IP address. Further, since the mobile station 1 is provided with the global IP address generated by the GGSN 4, there is no need to perform operations 213, 214, 215, and 216 of generating the global IP address.

Meanwhile, the above-described embodiments of the present invention may be embodied as computer programs that are stored in a computer readable medium and are executed in a general purpose digital computer.

Further, the data structure used in the embodiments of the present invention can be recorded in computer readable recording media using various tools.

Examples of computer readable recording media include magnetic storage media (e.g., ROM, floppy disks, hard disks, etc.), optical recording media (e.g., CD-ROMs, or DVDs), and storage media such as carrier waves (e.g., transmission through the Internet).

According to the present invention, the GGSN generates an IP address that can be used for communication through every multiple interface and provides the generated IP address to a mobile station. Therefore, it is unnecessary for the mobile station to generate an IP address for each of the multiple interfaces. Therefore, assigning too many IP addresses to one mobile station can be prevented, and the amount of time consumed for generating an IP address for each of the multiple interfaces is reduced.

In particular, according to the present invention, since even when an interface is changed in a subnet having the same network prefix, an identical address can be consistently used, duplicate address detection causing loss of a large number of packets and performance deterioration is unnecessary, thereby ensuring reliable, speedy communication.

In addition, according to the present invention, because the mobile station generates a link local IP address, there is no need to manage the interface ID pool in the GGSN and to limit the number of mobile stations connected to the GGSN in consideration of the capacity limit of the interface identifier pool.

Although a few embodiments of the present invention have been shown and described, it would be appreciated by those skilled in the art that changes may be made in these embodiments without departing from the principles and spirit of the invention, the scope of which is defined in the claims and their equivalents.

1. A communication method in a mobile station in which multiple interfaces complying with different communication standards are loaded, the method comprising:
(a) obtaining an address that can be used in communication through every one of the multiple interfaces based on information regarding a predetermined interface among the multiple interfaces; and
(b) performing communication through one of the multiple interfaces using the address obtained in (a).

2. The communication method of claim 1, wherein the address is generated by an external device in (a).

3. The communication method of claim 2, wherein the external device is a GGSN (Gateway GPRS (General Packet Radio Service) Support Node) according to the 3GPP (3 Generation Partnership Project) standard.

4. The communication method of claim 1, further comprising generating a local address that can be used in local communication through the predetermined interface based on the information,
wherein the address obtained in (a) is a global address converted from the local address.

5. The communication method of claim 4, wherein the information is a media access control (MAC) address according to the IEEE 802 standard, the local address is a link local IP address according to the IPv6 (Internet Protocol version 6) standard, and the global address is a global IP address according to the IPv6 standard.

6. The communication method of claim 1, wherein the multiple interfaces include a 3GPP interface and a WLAN (Wireless LAN (Local Area Network)) interface, and the predetermined interface is the WLAN interface, or the multiple interfaces include a 3GPP interface and a Bluetooth interface, and the predetermined interface is the Bluetooth interface.

7. A communication apparatus in a mobile station in which multiple interfaces complying with different communication standards are loaded, the communication apparatus comprising:
an address obtaining unit obtaining an address that can be used in communication through every one of the multiple interfaces based on information regarding a predetermined interface among the multiple interfaces; and
a communication performing unit performing communication through one of the multiple interfaces using the address obtained in the address obtaining unit.

8. An address obtaining method in a mobile station in which multiple interfaces complying with different communication standards are loaded, the method comprising:
(a) requesting an address that can be used in communication through every one of the multiple interfaces;
(b) receiving a response to the request in (a); and
(c) extracting the address from the response received in (b).

9. The address obtaining method of claim 8, wherein, in (a), an external device is requested to generate a global address.

10. The address obtaining method of claim 9, wherein the external device is a GGSN (Gateway GPRS (General Packet Radio Service) Support Node) according to the 3GPP (3 Generation Partnership Project) standard.

11. The address obtaining method of claim 8, wherein a request including a local address that can be used in local communication through a predetermined interface among the multiple interfaces in (a), and a response including a global address converted from the local address is received in (b).

12. The address obtaining method of claim 11, wherein an activate PDP (Packet Data Protocol) context request message including the local address is transmitted to an SGSN (Serving GPRS (General Packet Radio Service) Support Node) in (a), and an activate PDP context accept message, which is a response to the activate PDP context request message, is received in (b).

13. The address obtaining method of claim 11, wherein the information is a media access control (MAC) address according to the IEEE 802 standard, the local address is a link local IP address according to the IPv6 (Internet Protocol version 6) standard, and the global address is a global IP address according to the IPv6 standard.

14. An address providing method comprising:
(a) generating an address that can be used in communication through every one of multiple interfaces based on information regarding a predetermined interface among multiple interfaces complying with different communication standards; and
(b) transmitting the address generated in (a) to a mobile station in which the multiple interfaces are loaded.

15. The address providing method of claim 14, further comprising receiving a request for the address issued by the mobile station,
wherein, in (b), the address is transmitted in response to the request for the address.

16. The address providing method of claim 14, wherein the address generated in (a) is a global address converted from a local address that can be used in local communication through the predetermined interface.

17. The address providing method of claim 16, further comprising checking whether the local address is in use by another mobile station,
wherein the global address is generated from the local address in (a) if the local address is not in use by another mobile station.

18. The address providing method of claim 16, wherein the information is a media access control (MAC) address according to the IEEE 802 standard, the local address is a link local IP address according to the IPv6 (Internet Protocol version 6) standard, and the global address is a global IP address according to the IPv6 standard.

19. The address providing method of claim 14, wherein a create PDP context response message including a global address is transmitted via a SGSN (Serving GPRS (General Packet Radio Service) Support Node) in (b).

20. A computer readable storage for controlling a computer according to a communication method in a mobile station in which multiple interfaces complying with different communication standards are loaded, the communication method comprising:
obtaining an address that can be used in communication through every one of the multiple interfaces based on information regarding a predetermined interface among the multiple interfaces; and
performing communication through one of the multiple interfaces using the obtained address.

21. A communication method in a mobile station in which multiple interfaces complying with different communication standards are loaded, the method comprising:
obtaining an address that can be used to communicate through a plurality of the interfaces based on information regarding a predetermined interface among the multiple interfaces.

22. The communication method of claim 21, wherein the obtained address can be used to communicate through every one of the interfaces.

23. The communication method of claim 22, wherein the operation of obtaining an address is a single operation.

24. The communication method of claim 23, wherein the single operation comprises a request and a response to the request.
